(19) United States
(12) Patent Application Publication
(10) Pub. No.: US 2009/0226724 A1
(43) Pub. Date: Sep. 10, 2009

(54) MULTIFUNCTIONAL NANOSTRUCTURE AND METHOD

(75) Inventors: Dongling Ma, Ottawa (CA); Benoit Simard, Orleans (CA)

Correspondence Address: MARKS & CLERK, P.O. BOX 957, STATION B, OTTAWA, ON, K1P 5S7, CA

(73) Assignee: NATIONAL RESEARCH COUNCIL OF CANADA, OTTAWA, ON (CA)

(21) Appl. No.: 12/094,992

(22) PCT Filed: Nov. 28, 2006
(86) PCT No.: PCT/CA06/01935

§ 371 Date: Nov. 28, 2008

Related U.S. Application Data
(60) Provisional application No. 60/739,925, filed on Nov. 28, 2005.

(51) Int. Cl. B32B 9/04; B05D 7/00; B01J 13/02; B82B 1/00; B82B 3/00

(52) U.S. Cl. 428/403; 427/214; 427/213.3; 977/773; 977/774; 977/920; 977/892

(57) ABSTRACT

A functional nanoparticle for use in the ultrasensitive identification of bacteria and gene species has a magnetic core, an insulating first shell surrounding the magnetic core, and a luminescent second shell surrounding the first shell.

### FIELD OF THE INVENTION

This invention relates to the field of nanotechnology, and in particular to a novel nanostructure and a method of making the nanostructure.

### BACKGROUND OF THE INVENTION

The rapid and ultrasensitive identification of pathogenic bacteria and gene species is extremely important in clinical diagnostics, gene therapy, public security, biomedical studies and biotechnology development. The main problems hindering the realization of highly efficient identification techniques are the inability to identify simultaneously multiple pathogens, the inability to detect genes without Polymerase Chain Reaction (PCR) amplification, the need to wait for cultures, and the difficulty in separating the pathogens from the human genome.

Nanotechnology shows considerable promise in offering a solution to these problems. Various techniques have been proposed using suitable superparamagnetic materials to realize powerful separation and collection, utilizing highly sensitive and photostable signaling materials, such as quantum dots and dye doped nanoparticles, to realize highly sensitive detection, and employing multi-functional nanomaterials, such superparamagnetic nanoparticles with fluorophores attached to their surface for highly efficient multiplex applications.

Drawbacks of the prior art include the loss of stability of the superparamagnetic nanoparticles once exposed to biological environments; the lack of detection channels for quantum dots in conventional scanners in biological labs and possible toxicity of quantum dots; and luminescence quenching of any nearby luminophores by superparamagnetic nanoparticles.

Specific reference is made to the following papers, which are herein incorporated by reference: D. K. Yi, et al., J. Am. Chem. Soc. 2005, 127, 4990; X. Zhao, et al., Anal. Chem. 2003, 75, 3476-3483; H. Kim, et al., J. Am. Chem. Soc., 2005, 127, 544-546; S. Santra, et al., Anal. Chem. 2001, 73, 4988-4993.

U.S. Pat. No. 6,514,767 describes glass encapsulated composite nanoparticles with an active surface.

### SUMMARY OF THE INVENTION

In accordance with the principles of the present invention the two useful functions of superparamagnetism and luminescence, along with an easily manipulated surface of silica or surface of other suitable insulating material, are incorporated into one multifunctional nano-architecture.

According to a first aspect of the invention there is provided a functional nanoparticle comprising a magnetic core; an insulating first shell surrounding said magnetic core; and a luminescent second shell surrounding said first shell.

The direct attachment of dye molecules to magnetic nanoparticles causes the problem of luminescence quenching. In order to avoid this problem, a first insulating shell with a suitable thickness, silica in the present embodiment but could also be made of other insulating materials, must cover the magnetic cores to isolate them from the dye molecules. Subsequently, instead of attaching the dye molecules to the surface of this first shell directly, they are doped inside a second shell of the same insulating material, also silica in the present embodiment, to concentrate the emission signal and enhance the photostability of the dye.

A third insulating shell, also silica in the present embodiment can be grown to further provide protection and used for conjugation with various biospecies. The third shell can be grown by the same method as the second shell. These nano-complexes can be used for real-time in-situ monitoring diagnosis and therapy, such as targeted drug delivery.

The second shell can instead be made a luminescent semiconductor material such as CdSe. Many other compositions can be also used for the semiconductor material, such as CdTe, InP PbSe, and more generally II-VI (ex. Cd Chalcogenides) and III-V (ex. InP, GaAs) semiconductor nanocrystals. Also ternary systems such as CdTeSe can be employed.

Also, the core and first shell can constitute core-shell systems, such CdSe@ZnS.

The magnetic core can be FeₓO_{y}, and more generally it can consist of zero valent metals such Fe and Co, FeCo, SmCo5, FePt as well as ferrite materials such as MxFeyOz (where M=Co, Mn . . . ).

In another aspect the present invention provides a method of making functional nanoparticles, comprising preparing magnetic nanoparticles; coating said nanoparticles with an insulating first shell; and subsequently applying a luminescent second shell outside said first shell.

In the multifunctional device of the invention the magnetic and optical properties are compartmentalised and are physically and chemically isolated from each other within the body of the device.

The invention employs a two-step process: namely a modified Stöber method followed by a reverse micro-emulsion method to achieve the novel multifunctional core/multi-shell nano-architecture.

### BRIEF DESCRIPTION OF THE DRAWINGS

The invention will now be described in more detail, by way of example only, with reference to the accompanying drawings, in which:

FIG. 1 illustrates a novel nanoparticle in accordance with an embodiment of the invention; and

FIG. 2a is a TEM micrograph of FeₓO_{y} nanoparticles;

FIG. 2b is a TEM micrograph of FeₓO_{y}@SiO₂ nanoparticles formed by the modified Stöber method to be used for Rubpy doping;

FIGS. 2c and d are TEM micrographs of Rubpy doped FeₓO_{y}@SiO₂ nanoparticles prepared by the two-step method;

FIG. 2e is a TEM micrograph of an undoped FeₓO_{y}@SiO₂ nanoparticle with the shell thickness comparable to the Rubpy doped ones;

FIG. 2f is a histogram showing the particle size distribution of Rubpy-doped FeₓO_{y}@SiO₂ double-shell nanoparticles.

FIG. 3a is a TEM micrograph of Rubpy doped FeₓO_{y}@SiO₂ nanoparticles synthesized by the reverse microemulsion method;

FIG. 3B is a TEM micrograph of Rubpy doped SiO₂ nanoparticles prepared by the reverse microemulsion method (Arrows denote superparamagnetic cores); and

FIG. 4 is a plot showing integrated photoluminescence intensity versus absorbance at 450 nm for the neat Rubpy (squares), Rubpy-doped FeₓO_{y}@SiO₂ nanoparticles (circles) and Rubpy-doped silica nanoparticles (triangles).

### DETAILED DESCRIPTION OF THE PREFERRED EMBODIMENT

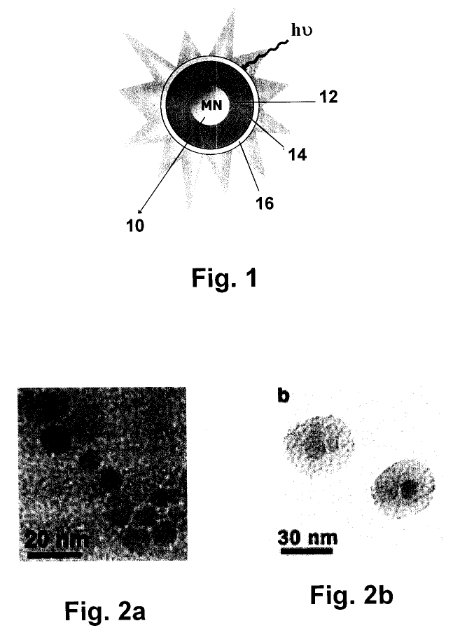

As shown in FIG. 1, the nanoparticles of the invention comprise a superparamagnetic core 10, for example, or an iron or cobalt-based compound, an insulating first shell 12 of a suitable insulating material, such as silica or Al₂O₃, a luminescent second shell 12, which can be dye- or quantum dot-doped, or made of a semiconducting material such as CdSe, and an optional outer insulating shell 16, which can be of any suitable insulating material, such as silica, that provides protection to the core and luminescent components, and has surface functionality so that it can bind to species to be studied.

The invention makes the novel nanoparticles using the Stöber method, described in W. Stober, et al. Journal of Colloid and Interface Science 26, pp. 62-69 (1968), and hereby incorporated herein by reference. In the Stöber method, tetraethylorthosilicate (TEOS), ammonium hydroxide (NH.sub.4 OH), and water are added to a glass beaker containing ethanol, and the mixture is stirred overnight. The size of the Stöber particles is dependent on the relative concentrations of the reactants.

Conventionally, the Stöber (or modified Stöber) method and reverse micro-emulsion method have been used independently to form silica particles or silica shells. The reverse micro-emulsion process is described in, for example, Tamkang Journal of Science and Engineering, Vol. 7, No 4, pp. 199-204 (2004), herein incorporated by reference. With the presence of the magnetic particles and dye molecules, the main problem in the development of the above-mentioned structure using the modified Stöber method is the formation of agglomeration and many core free silica particles, while those using the reverse micro-emulsion method is the formation of uncontrolled multi-core structure, agglomeration and as well as many core free silica particles.

By employing a novel two-step method: the modified Stöber method (the first step) followed by the reverse micro-emulsion method (the second step), much better results are obtained.

During the first step, a core-shell structure with a well controlled morphology and thickness of the first silica shell is synthesized using the modified Stöber process. During the second step, the second silica shell is grown and dye molecules are doped simultaneously in the nanoreactor in the reverse micro-emulsion.

The advantages of this combination are that a) the initial surfactants on the nanoparticle surface are removed during the first step, decreasing the complexity of the subsequent reverse micro-emulsion system, and b) the products containing the first silica shell (10˜15 nm) act as “good” seeds for the second step, avoiding the formation of multi-core, too many core free particles and agglomeration.

### EXAMPLE

### Synthesis of Luminescent Core-Shell Nanoparticles Via Novel Two-Step Method

Iron oxide (FexOy) nanoparticles, dispersed in water, with a reported average size of 10 nm were purchased from Ferrotec (USA) Corporation with a commercial name of ferrofluid EMG 304.

Tris (2,2˜-bipyridine) ruthenium (II) chloride (Rubpy) was supplied by Alfa Aesar, Johnson Matthey Company. Tetraethoxysilane (TEOS) was obtained from Gelest Inc.

Ammonium hydroxide (NH 4OH, 28-30 wt %) and high purity isopropanol were both obtained from EMD Chemicals Inc. Triton X-100, cyclohexane and hexyl alcohol were purchased from Sigma-Aldrich Inc., BDH Inc. and Anachemia Canada Inc., respectively.

All chemicals were used directly without further purification. Throughout the preparation, purified water (18 M˜cm) was used exclusively. Water was purified using a Millipore Q-guard® 2 purification system (Millipore Corporation).

The first step is coating the iron oxide (FeₓO_{y}) nanoparticles with silica to form the dye-free FeₓO_{y}@SiO₂ core-shell nanoparticles with the shell thickness around 12 nm. The nanoparticles were prepared via the modified Stöber method. Typically, 200 ml of Tetraethoxysilane (TEOS, Gelest Inc) solution in isopropanol (1 mM) was added to 28 ml of FeₓO_{y} particle aqueous dispersion (particle number concentration: ˜9×10¹²/ml) under vigorous stirring. Then, 3 ml of NH₄OH (28-30 wt %, EMD Chemicals Inc.) was added drop wise to the reaction mixture. The reaction was allowed to proceed for at least 5 hrs at room temperature. Finally, brown colored core-shell nanoparticles were collected by centrifugation and washed with water for several times. Then the nanoparticles were dispersed into water for subsequent coating and doping processes.

The second step is encapsulating the Rubpy dye into the second silica shell, which is produced simultaneously during the doping process, through the reverse microemulsion method reported in S. Santra, P. Zhang, K. Wang, R. Tapec and W. Tan, Anal. Chem. 2001, 73, 4988 with minor modifications. The water-in-oil microemulsion was prepared by mixing 1.8 ml of Triton X-100 (Sigma-Aldrich Inc.), 7.5 ml of cyclohexane (BDH Inc.), 1.8 ml of hexyl alcohol (98%, Anachemia Canada Inc.), and 340 μl of water.

2 ml of FeₓO_{y}@SiO₂ particle dispersion (particle number concentration: ˜9×10¹²/ml) and 774 μl of Rubpy (Alfa Aesar, Johnson Matthey Co.) water solution (2.58 mg/ml) were added to the microemulsion and sonicated to get a uniform dispersion.

The silica coating reaction was started by adding 25 μl of TEOS and 14.7 μl of NH₄OH. The reaction was allowed to continue over 4 days under gentle shaking in an aluminum foil-covered reactor. To stop reaction, acetone was added and the nanoparticles were separated by centrifugation. As in the first step, the nanoparticles were repeatedly washed for several times to remove un-reacted reagents.

In an alternative embodiment, both growth of the inner silica shell and the growth of the dye-doped outer shell were carried out in the reverse microemulsion. The water-in-oil microemulsion was prepared the same way as described above by mixing 1.8 ml of Triton X-100, 7.5 ml of cyclo-hexane, 1.8 ml of hexyl alcohol, and 340˜l of water. Next, 2.774 ml of water-dispersed FexOy (particle number concentration: ˜1013 ml-l) was added to the microemulsion to form uniform particle dispersion. Subsequently, 15˜l of TEOS and 8.8˜l of NH4OH were added to the mixture to coat the FexOy nanoparticles with the first silica shell. The reaction was stopped after 24 hr. The un-doped FexOy@SiO2 core-shell nanoparticles were washed and redispersed in 2 ml of water for subsequent processing. The growth of the dye-doped outer silica shell was performed the same way as described above.

The nucleation and growth of the silica nanoparticles and the Rubpy doping process were accomplished simultaneously in a one-pot reaction. The water-in-oil microemulsion was prepared by mixing 1.8 ml of Triton X-100, 7.5 ml of cyclohexane, 1.8 ml of hexyl alcohol, and 340˜l of water. Then, 774˜l of Rubpy water solution (10.3 mg/ml) was added to the microemulsion and sonicated to get a uniform dispersion. Subsequently, 100˜l of TEOS and 14.7˜l of NH4OH were added. The reaction was allowed to continue over 4 days under gentle shaking in an aluminum foil-covered reactor. Following termination of the reaction by adding acetone luminescent nanoparticles were extracted by centrifugation and washed with water and ethanol to remove un-reacted reagents. The purified luminescent nanoparticles were then dispersed in water for characterization.

Transmission electron microscopy (TEM) images were obtained using a Philips CM20 FEG microscope operating at 200 kV. The samples were prepared by dropping several drops of the particle aqueous dispersion onto the grids.

UV-visible spectra were acquired by using Cary 5000 UV-Vis-NIR Spectrophotometer (Varian) with the scan speed of 300 nm/min. Emission spectra were measured with C700 PTI system (Photon Technology International) equipped with a Xenon lamp using excitation wavelength of 450 nm. Lifetime measurement was performed with a Fluorolog-Tau-3 Lifetime System (Jobin Yvon Inc.). All the samples tested were dispersed in water and had the absorbance equal to or below 0.1. The phase shift and demodulation factor data were recorded at a series of frequencies and the lifetime was obtained by fitting both sets of data versus the frequencies with basic lifetime modeling software (version 2.2.12) provided by the manufacturer. κ² is used to evaluate the validity of the data fit and the fit with the κ² value close to or smaller than 1 is thought as satisfying.

The magnetic properties of the nanoparticles were studied with a Quantum Design PPMS Model 6000 Magnetometer. The nanoparticles, in powder form, were inserted in a gelatin capsule and sealed with parafilm. Field dependent magnetization was measured at 300 K for magnetic fields up to 4 tesla (T). Temperature-dependent zero-field-cooled (ZFC) and field-cooled (FC) magnetization was measured in the range 10-350 K by initially cooling the samples to 2 K in zero and 50 oersted (Oe) fields, respectively.

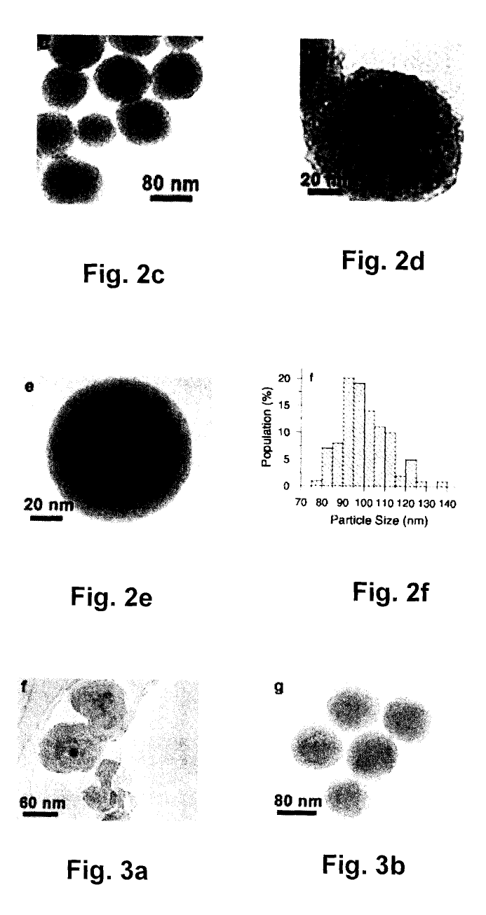

The Iron oxide nanoparticles (EMG 304) were stabilized with surfactants in water. The TEM image (FIG. 2a) shows that the particle diameter ranges from 5 to 24 nm with the mean value of 9.7 nm and the standard deviation of 0.4 nm determined from a log-normal fitting.

The production process of the inner silica shell encapsulating the FeₓO_{y} nanoparticles results in hybrid nanoparticles most of which have either a single or double cores with a small number of them having multiple cores (FIG. 2b)). The shell surface appears smooth and the average shell thickness is about 12 nm. The shell thickness has been well controlled by adjusting the TEOS concentration. It can be varied from a few nanometer to over 100 nm.

The particle size becomes much larger after growing the outer silica shell impregnated with Rubpy molecules (FIG. 2c). The diameter ranges from about 80 to over 130 nm (FIG. 2f). The size distribution is fitted to a log-normal shape, yielding the mean diameter of 98.2 nm and the standard deviation of 0.1. The large-sized particles contain double or multi-cores. There is a small portion of core-free nanoparticles but they are not counted into the particle size distribution. The thickness of the double shell of most of particles is 40-50 nm. The shell thickness depends on the TEOS, water, and NH₄OH concentrations as well as reaction time.

The outer silica shell is less compact than the dye-free shell. As seen more clearly from high magnification TEM images (FIGS. 2d and 2e), the Rubpy-doped FeₓO_{y}@SiO₂ nanoparticles exhibit a random contrast variation and coarser shell texture as compared with the dye-free FeₓO_{y}@SiO₂ nanoparticles with similar shell thickness. This is possibly due to perturbation of the silica network by the dye molecules. It should be pointed out that, unlike the surface of the inner dye-free shell, the surface of the dye-doped outer silica shell is relatively rough.

For comparison, a TEM image of Rubpy-doped FeₓO_{y}@SiO₂ nanoparticles prepared via the reverse microemulsion method is shown in FIG. 3a, where multi-core structures and aggregates along with core-free silica nanoparticles are evident. In addition, magnetic particle-doped silica networks are also observed (not shown in FIG. 3a). The formation of inferior structures is likely due to the magnetic dipolar interactions among the magnetic particles, which perturb the aggregation state of the surfactants and disturb the local stability of the reverse microemulsion system. In addition, the surfactants on the as-received FeₓO_{y} particle surface can also have unknown effects to morphology of the microemulsion. It is thought that the reaction environment in each single micelle may not be completely homogeneous during the coating process.

The morphology of the luminescent FeₓO_{y}@SiO₂ nanoparticles prepared by the two-step method of the invention is superior to the nanoparticles grown by the reverse microemulsion method.

The synthesis of Rubpy-doped nanoparticles via the reverse microemulsion method is rather straightforward in the absence of magnetic nanoparticles and yields regular, approximately spherical isolated nanoparticles, as shown in the FIG. 3b. These results indirectly validate the above explanation for the inferior morphology of the magnetic nanoparticle-containing structures formed when only the reverse microemulsion technique is used. The decrease of interparticle dipolar interactions and removal of the surfactants on the FeₓO_{y} particle surface in the first-step of silica coating facilitate formation of a better structure in the second step carried out in the reverse microemulsion.

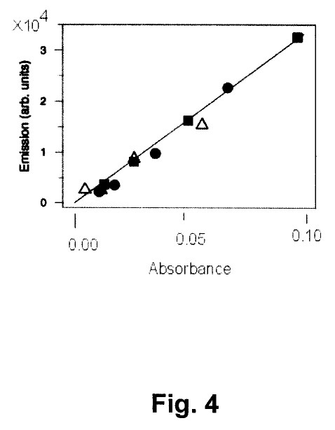

Photoluminescence intensities (integrated between 515 and 800 nm) of Rubpy in water, embedded in the FeₓO_{y}@SiO₂ nanoparticles, and embedded in silica nanoparticles synthesized via the reverse microemulsion method have been studied as a function of absorbance at 450 nm to determine the effects of the host silica and the magnetic core on photoluminescence efficiency of Rubpy. As shown in FIG. 4, the integrated intensities of Rubpy in all three environments vary linearly with absorbance and are approximately equal, within experimental precision, at a given absorbance value. It appears that, first, embedment of Rubpy molecules in silica does not affect their photoluminescence efficiency and, second, magnetic core separated from the silica-embedded Rubpy molecules by ˜12 nm or more does not quench the Rubpy photoluminescence.

The two-step approach, combining sequentially the Stöber method and the reverse microemulsion method, to synthesize multifunctional core-shell nanoparticles results in an improved structure showing efficient combination of both superparamagnetism and luminescence. The core-shell architecture contains a superparamagnetic core, an insulating dye-free silica shell, a dye-doped silica shell and a functionalizeable silica surface. The insulating silica shell plays two roles: prevents dye luminescence quenching and minimizes magnetic core to core coupling.

Optical measurements demonstrate that the free dye and the embedded dye display similar absorption and emission properties and show a similar quantum yield, thus confirming that the presence of the insulating silica shell of 12 nm efficiently prevents the “optical” interaction between the Rubpy and the magnetic core. An important key factor leading to the success in synthesizing this fine multifunctional nano-architecture is the use of apparent/silica nanoparticles, actually containing encapsulated magnetic cores, in the reverse microemulsion for the Rubpy doping process.

The same or slightly modified reverse microemulsion conditions should be applicable to dye doping of various magnetic nanoparticles as long as they are already covered by silica shells sufficiently thick to isolate their magnetic interactions. The described method should be generally applicable to most of the magnetic nanoparticles dispersible in water. Because the reverse micro-emulsion method requires specific surfactants, the direct use of this method has restrictions on the surfactants used for the initial nanoparticle synthesis.

The process can be modified to accommodate various dyes or quantum dots into the silica shell to meet different detection requirements.

The invention offers the prospect of the efficient capture, pre-concentration and transport of pathogenic bacteria and gene species; highly sensitive detection; real-time in-situ tracking of capture process; and real-time in-situ monitoring therapeutic process (e.g. targeted drug delivery, cancer tissue killing process).

We claim:

1. A functional nanoparticle comprising:
a magnetic core;
an insulating first shell surrounding said magnetic core; and
a luminescent second shell surrounding said first shell.

2. A functional nanoparticle as claimed in claim 1, wherein said second shell is doped with material selected from the group consisting of quantum dots and dye.

3. (canceled)

4. A functional nanoparticle as claimed in claim 1, wherein the second shell is made of semiconductor material selected from the group consisting of II-VI and III-V semiconductor nanocrystals.

5. A functional nanoparticle as claimed in claim 4, wherein the semiconductor material is selected from the group consisting of Cd Chalcogenides, InP, GaAs, CdTe, InP, and PbSe.

6. (canceled)

7. A functional nanoparticle as claimed in claim 4, wherein said semiconductor material is CdSe.

8. (canceled)

9. A functional nanoparticle as claimed in claim 1, wherein the second shell is made of CdTeSe.

10. (canceled)

11. A functional nanoparticle as claimed in claim 1, wherein the core and first and shell constitute a CdSe@ZnS nanoparticle core-shell system.

12. A functional nanoparticle as claimed in claim 1, wherein the magnetic core is selected from the group consisting of zero valent metals and ferrite materials.

13. A functional nanoparticle as claimed in claim 1, wherein the magnetic core is selected from the group consisting of Fe, Co, FeCo, SmCo₅, FePt, and MₓFe_{y}O_{z} (where M=Co, Mn . . . ).

14. A functional nanoparticle as claimed in claim 1, wherein said magnetic core is FeₓO_{y}.

15. A functional nanoparticle as claimed in claim 1, wherein said first and second shells are silica.

16. A functional nanoparticle as claimed in claim 1, further comprising an insulating third shell with surface functionality surrounding the second shell.

17. A functional nanoparticle as claimed in claim 16, wherein said third shell is silica.

18. A method of making functional nanoparticles, comprising:
preparing magnetic nanoparticles;
coating said nanoparticles with an insulating first shell; and
subsequently applying a luminescent second shell outside said first shell.

19. A method as claimed in claim 18, wherein said first shell is applied by the Stober method and said second shell is applied by the reverse microemulsion method.

20. (canceled)

21. A method as claimed in claim 18, comprising forming a third shell with a functional surface outside said second shell.

22. A method as claimed in claim 18, comprising doping said second shell with a luminescence material selected from the group consisting of dyes and quantum dots during growth thereof.

23. (canceled)

24. A method as claimed in claim 22, wherein said luminescence material is Rubpy dye.

25. (canceled)

26. A method as claimed in claim 18, wherein said second shell is made of CdSe.

27. A method as claimed in claim 18, wherein the magnetic core is FeₓO_{y}.

28. A method as claimed claim 18, wherein each of said shells is silica.

29. (canceled)

30. A method as claimed in claim 18, wherein the core and first shell constitute a CdSe@ZnS nanoparticle core-shell system.
